(19) United States
(12) Patent Application Publication
(10) Pub. No.: US 2023/0168428 A1
(43) Pub. Date: Jun. 1, 2023

(54) METHOD FOR MANUFACTURING LOW LOSS OPTICAL FIBERS

(71) Applicant: CORNING INCORPORATED, Corning, NY (US)

(72) Inventors: Rostislav Radiyevich Khrapko, Corning, NY (US); Hazel Benton Matthews, III, Wilmington, NC (US); Pushkar Tandon, Painted Post, NY (US)

(21) Appl. No.: 17/989,988

(22) Filed: Nov. 18, 2022

Related U.S. Application Data
(60) Provisional application No. 63/283,604, filed on Nov. 29, 2021.

(51) Int. Cl. G02B 6/02; G02B 6/028; C03B 37/012

(52) U.S. Cl. CPC G02B 6/02123; G02B 6/0286; C03B 37/0122; C03B 37/01217; C03B 2201/12; C03B 2201/06

(57) ABSTRACT

An optical fiber includes a core region of silica glass doped with an alkali metal oxide. A depressed-index cladding region surrounds the core region and comprises silica glass doped with a first concentration of fluorine. The depressed-index cladding region has a minimum relative refractive index Δ₃ₘᵢₙ in a range from −0.80% to −0.30%. An outer cladding region comprises silica glass doped with a second, lesser concentration. The outer cladding region has a relative refractive index Δ₄, where Δ₄−Δ₃ₘᵢₙ>0.05%. The optical fiber has a time-to-peak hydrogen aging value at 23° C. of less than 100 hours upon exposure to an atmosphere having a total pressure of 1 atm and containing a partial pressure of 0.01 atm H₂ and a partial pressure of 0.99 atm N₂. The optical fiber exhibits an attenuation <0.16 dB/km.

This application claims the benefit of priority to U.S. Provisional Patent Application Ser. No. 63/283,604 filed on Nov. 29, 2021, the content of which is relied upon and incorporated herein by reference in its entirety.

### FIELD OF THE DISCLOSURE

The present disclosure relates to optical fibers. More specifically, the present disclosure relates to a method of manufacturing low loss optical fibers with low water peak and low attenuation for C-band and L-band transmission.

### BACKGROUND

Optical fibers are utilized in a variety of telecommunication applications. Manufacturing processes for producing optical fibers typically include drawing an optical fiber from a heated glass preform in a draw furnace, cooling the drawn optical fiber, and coating the optical fiber.

### SUMMARY OF THE DISCLOSURE

According to one aspect of the present disclosure, a method of manufacturing a preform of an optical fiber where the optical fiber has a core region and a cladding region includes forming a porous cladding soot blank by depositing silica soot on a core cane. The core cane includes a core portion having a composition corresponding to at least a portion of the core region of the optical fiber and a concentration of an alkali metal oxide in a core portion of the core cane is between 0.1 wt. % and 1.5 wt. %. The method includes exposing the porous cladding soot blank to a fluorine-doping precursor in the presence of SiCl₄, the fluorine-doping precursor doping the porous cladding soot blank with fluorine to form a fluorine-doped porous cladding soot blank. The exposing comprises providing a flow of the fluorine-doping precursor to the porous cladding soot blank. The method includes consolidating the fluorine-doped porous cladding soot blank in presence or absence of a fluorine-doping precursor to form a consolidated fluorine-doped cladding cane, the consolidating comprising exposing the fluorine-doped porous cladding soot blank to SiCl₄. The composition of the core portion of the core cane comprises silica doped with an alkali metal oxide.

According to another aspect of the present disclosure, a method of manufacturing an optical fiber where the optical fiber has a core region and a cladding region includes forming an alkali-doped core cane. The alkali-doped core cane includes a portion having a composition corresponding to at least a portion of the core region of the optical fiber. The method includes forming a porous cladding soot blank by depositing silica soot on the alkali-doped core cane and exposing the porous cladding soot blank to a fluorine-doping precursor. The fluorine-doping precursor dopes the silica soot with fluorine to form a fluorine-doped porous cladding soot blank. The step of exposing comprises providing a flow of the fluorine-doping precursor to the porous cladding soot blank. The method includes consolidating the fluorine-doped porous cladding soot blank in the absence or presence of the flow of the fluorine-doping precursor to form a fluorine-doped cladding cane, the fluorine-doped cladding cane having a portion with a composition corresponding to the cladding region of the optical fiber. The step of exposing comprises exposing the porous cladding soot blank to the fluorine-doping precursor in the presence of SiCl₄ or the step of consolidating comprises exposing the fluorine-doped porous cladding soot blank to SiCl₄.

According to another aspect of the present disclosure, an optical fiber includes a core region, the core region comprising silica glass doped with an alkali metal oxide. A cladding region surrounds and is directly adjacent to the core region. The cladding region comprises a depressed-index cladding region surrounding the core region. The depressed-index cladding region comprises silica glass doped with a first concentration of fluorine. The depressed-index cladding region has a relative refractive index Δ₃ with a minimum relative refractive index Δ₃ₘᵢₙ in a range from −0.80% to −0.30%. The cladding region includes an outer cladding region surrounding and directly adjacent to the depressed-index cladding region. The outer cladding region comprises silica glass doped with a second concentration of fluorine less than the first concentration of fluorine. The outer cladding region has a relative refractive index Δ₄ such that Δ₄−Δ₃ₘᵢₙ>0.05%. The optical fiber has a time-to-peak (TTP) hydrogen aging value at 23° C. of less than 100 hours upon exposure of the optical fiber to a gas atmosphere having a total pressure of 1 atm and containing a partial pressure of 0.01 atm H₂ and a partial pressure of 0.99 atm N₂. The optical fiber exhibits an attenuation <0.16 dB/km at 1583 nm and the attenuation monotonically increases between about 1570 nm and about 1600 nm.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a cross-sectional schematic diagram of an optical fiber, according to the present disclosure;

FIG. 2 is an exemplary step index refractive index profile of an optical fiber having an alkali metal oxide concentration that varies with a radius of the optical fiber, according to the present disclosure;

FIG. 3 is an exemplary K₂O concentration profile of an optical fiber, according to the present disclosure;

FIG. 4 is an exemplary relative refractive index profile of an optical fiber, according to the present disclosure;

FIG. 5 is an exemplary relative refractive index profile of an optical fiber, according to the present disclosure;

FIG. 6 is an exemplary relative refractive index profile of an optical fiber, according to the present disclosure;

FIG. 7A is an exemplary relative refractive index profile of an optical fiber, according to the present disclosure;

FIG. 7B is an exemplary relative refractive index profile of an optical fiber, according to the present disclosure;

FIG. 8 is a schematic diagram illustrating a process for depositing glass soot, according to the present disclosure;

FIG. 9 is a schematic diagram of a method for doping a glass tube with an alkali metal oxide, according to the present disclosure;

FIG. 10 is a flow diagram of a method for manufacturing an alkali metal doped optical fiber, according to the present disclosure;

FIG. 11 is a flow diagram of a method for manufacturing an alkali-doped optical fiber, according to the present disclosure;

FIG. 12 is a graph comparing attenuation in an optical fiber when carbon monoxide is used as a reducing agent and attenuation in an optical fiber when a non-carbon reducing agent is used as a reducing agent, according to the present disclosure;

FIG. 13 is illustrative of diffusion of an exemplary alkali metal oxide diffused into an optical fiber, according to the present disclosure;

FIG. 14 is a schematic diagram of a process for redrawing a glass rod, according to the present disclosure;

FIG. 15 is a schematic diagram of a process for drawing an optical fiber from a preform, according to the present disclosure;

FIG. 16 is an exemplary refractive index profile of a core cane where a non-carbon reducing agent was utilized in a manufacturing process, according to the present disclosure; and

FIG. 17 is an exemplary refractive index profile of an optical fiber where a non-carbon reducing agent was utilized in a manufacturing process, according to the present disclosure

### DETAILED DESCRIPTION OF THE PREFERRED EMBODIMENTS

Additional features and advantages will be set forth in the detailed description that follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Directional terms as used herein—for example up, down, right, left, front, back, top, bottom—are made only with reference to the figures as drawn and are not intended to imply absolute orientation.

“Radial position,” “radial distance,” or the radial coordinate “r” refers to radial position relative to the centerline (r=0) of the core in the optical fiber. The length dimension “micron” may be referred to herein as micron or μm.

The “refractive index profile” is the relationship between refractive index, or relative refractive index, and the radial distance r from the centerline of the core. For relative refractive index profiles depicted herein as having step boundaries between adjacent cladding regions, normal variations in processing conditions may preclude obtaining sharp step boundaries at the interface of adjacent regions. It is to be understood that although boundaries of refractive index profiles may be depicted herein as step changes in the refractive index, the boundaries in practice may be rounded, or otherwise deviate from perfect step function characteristics. It is further understood that the value of the relative refractive index may vary with radial position within the core region and/or any of the cladding regions.

When relative refractive index varies with radial position in a particular region of the fiber (core region and/or any of the cladding regions), it may be expressed in terms of its actual or approximate functional dependence or in terms of an average value applicable to the region. Unless otherwise specified, if the relative refractive index of a region (core region and/or any of the cladding regions) is expressed as a single value, it is understood that the relative refractive index in the region is constant, or approximately constant, and corresponds to the single value or that the single value represents an average value of a non-constant relative refractive index dependence with radial position in the region. Whether by design or a consequence of normal manufacturing variability, the dependence of relative refractive index on radial position may be sloped, curved, or otherwise non-constant.

The “relative refractive index” or “relative refractive index percent” as used herein with respect to optical fibers and fiber cores of optical fibers is defined as:

$$Δ \% = 100 \frac{{n}^{2} ( r ) - {n}_{c}^{2}}{2 {n}^{2} ( r )}$$

where n(r) is the refractive index at the radial distance r from the centerline of the core at a wavelength of 1550 nm, unless otherwise specified, and n_{c} is about 1.444, which is the refractive index of undoped silica glass at a wavelength of 1550 nm. As used herein, the relative refractive index is represented by Δ (or “delta”) or Δ % (or “delta %) and its values are given in units of “%” unless otherwise specified. Relative refractive index may also be expressed as Δ(r) or Δ(r) %. When the refractive index of a region is less than the reference index n_{c}, the relative refractive index is negative and can be referred to as a depressed-index region, a trench, or a moat. When the refractive index of a region is greater than the reference index n_{c}, the relative refractive index is positive and the region can be said to be raised or to have a positive index.

Moreover, the term “α-profile,” also referred to as an “alpha profile”, refers to a relative refractive index profile Δ(r) that has the following functional form:

$$Δ ( r ) = {Δ ( {r}_{0} ) [ 1 - \frac{\vert r - {r}_{0} \vert}{( {r}_{1} - {r}_{0} )} ]}^{α}$$

where rₒ is the point at which Δ(r) is maximum, r₁ is the point at which Δ(r) is zero, and r is in the range rᵢ≤r≤r_{f}, where rᵢ is the initial point of the α-profile, r_{f} is the point of the α-profile, and α is a real number. In some embodiments, examples shown herein can have a core alpha of 1≤α≤100. In practice, even when the target profile is an alpha profile, some level of deviation from the ideal configuration can occur. Therefore, the alpha parameter for an optical fiber may be obtained from the best fit of the measured index profile, as is known in the art.

The disclosure herein related to an optical fiber preform (also referred to herein as a “preform”) or elements used in fabrication thereof such as, for example, a cane, rod, soot blank, or deposition tube. A core cane or core rod is a consolidated glass body having a composition corresponding to at least a portion of the core or core region of an optical fiber drawn from the preform. An optical fiber preform is a consolidated glass article suitable for drawing into an optical fiber. An optical fiber preform includes a central core region surrounded by one or more cladding regions, where the refractive indices of the core region and cladding region(s) are configured such that an optical fiber drawn from the complete optical fiber preform acts as a waveguide for light having a wavelength of 1550 nm. Additionally, as used herein, a “cane,” a “core region” or “core,” a “cladding region” or “cladding”, and other similar terms mean consolidated glass. In some embodiments, the consolidated glass is prepared by depositing soot (e.g., soot particles comprising silica or doped silica) to form a porous body (e.g., core soot to form porous core soot blank or cladding soot to form porous cladding soot blank) and consolidating the soot. In some embodiments, a porous body is formed on consolidated glass (e.g., cladding soot deposited on a core cane to form a porous cladding soot blank).

As used herein, “ppm,” unless otherwise specifically noted otherwise, refers to parts per million by weight, or “ppm by weight,” or “ppm by Wt,” and a measurement in weight percent (wt %) can be converted to ppm by multiplying by a factor of 10,000.

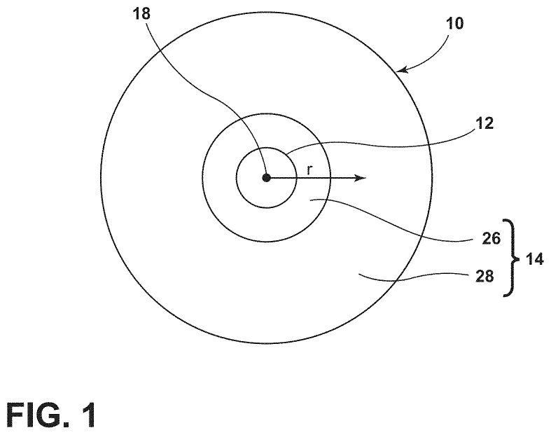

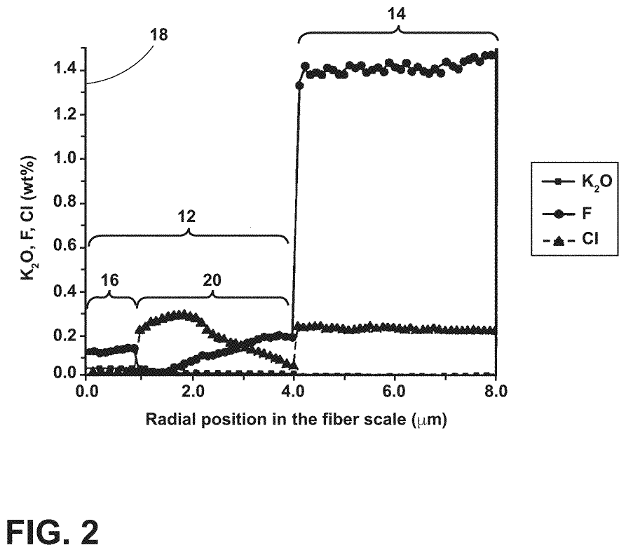

Referring to FIGS. 1 and 2, an optical fiber 10 disclosed herein includes a core region or core 12 and a cladding region or cladding 14 surrounding the core 12. The core 12 refers to a portion of the optical fiber 10, which has a generally raised index of refraction relative to the cladding 14, so that the transmitted optical power of guided light propagates predominately through the core 12. The core 12 generally has a non-negative relative refractive index relative to the cladding 14. The core 12 may include one or more regions. An individual core region may have a refractive index greater than pure silica, equal to pure silica, or less than pure silica. The cladding 14 may be an annular ring that surrounds and is directly adjacent to the core 12. The core 12 may have a radius r between about 2 microns and about 8 microns, between about 3 microns and about 6 microns, or between about 3.5 microns to about 4.5 microns. The core 12 may include a single core region, as illustrated, or alternatively multiple core regions within the core radius.

Dopants may be utilized to increase or decrease the relative refractive index of the core 12 and the cladding 14. An up-dopant is used to refer to a dopant that increases the relative refractive index relative to pure undoped silica. Non-limiting up-dopants include, for example, chlorine. Down-dopants are used to refer to a dopant that decreases the relative refractive index relative to undoped, pure silica. Non-limiting examples of down-dopants include, for example, fluorine and boron.

Referring to FIG. 2, the embodiments of the optical fiber 10 illustrated includes the silica-based core 12 extending from about 0 microns to about 4 microns. The cladding is fluorine-doped silica, and the fluorine-doped silica cladding 14 surrounds the core 12. The core 12 includes an alkali metal oxide as discussed further herein, with an average concentration between about 50 ppm by weight and about 500 ppm by weight. The core 12 may also include chlorine and/or fluorine. The average amount of chlorine and fluorine in the core 12 may be greater than the amount of alkali metal oxide.

In the illustrated example, the core 12 comprises a central core 16 region extending to about 1 micron located along a centerline 18 of the core 12. The central core region 16 contains a lower average concentration of chlorine than is contained in an outer core region 20, which extends around the central core region 16 from about 1 micron to about 4 microns of the core 12. The average concentration of chlorine present in the central core region 16 may be less than about 100 ppm or less than about 50 ppm. The average concentration of chlorine in the outer core region 20 may be greater than about 500 ppm, greater than about 750 ppm, greater than about 1000 ppm, or greater than about 1500 ppm. The peak concentration of chlorine in the core 12 is generally greater than about 500 ppm, greater than about 1000 ppm, or greater than about 1500 ppm.

The average concentration of fluorine present in the central core region 16 is generally greater than about 500 ppm, greater than about 750 ppm, or greater than about 1000 ppm. The average concentration of fluorine in the outer core region 20 is likewise greater than about 500 ppm, greater than about 750 ppm, or greater than about 1000 ppm. The average concentration of fluorine across the entire core 12 is generally greater than about 500 ppm and less than about 4000 ppm. The concentration of fluorine in the core 12 is generally between is between about 0.15 wt. % and about 0.25 wt. %. There is a low level of fluorine in the core 12, and the core 12 has a slightly positive delta due to potassium in the core 12.

The optical fiber 10 also includes the alkali metal oxide. The alkali metal oxide is generally an oxide of at least one of K, Na, Li, Cs, Rb, or combinations thereof. The alkali metal oxide may include at least one of K₂O, Na₂O, LiO₂, Rb₂O, Cs₂O, or combinations thereof. Generally, the concentration of the alkali metal oxide in the core region 12 is between 0.1 wt. % and 1.5 wt. %. In certain aspects, the alkali metal oxide may be formed from KI and O₂.

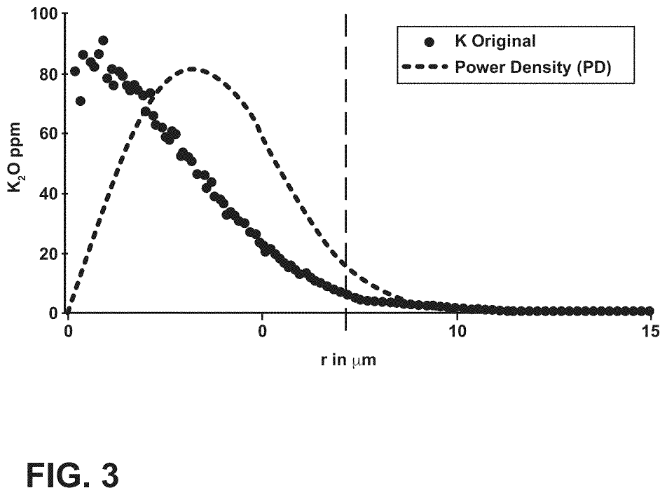

An exemplary concentration profile for a dopant is illustrated in FIG. 3. The optical fiber 10 includes the core 12 and the cladding 14, which surrounds the core 12. Generally, the alkali metal concentration varies as a function of radius r. The concentration of the alkali metal oxide may decrease as the radius r increases from the centerline 18 of the optical fiber 10 along at least a portion of the optical fiber radius r. The relative refractive index profile of the core 12 may have a step, rounded, alpha, or triangular shape. The illustrated K₂O profile of FIG. 3 was measured ToF-SIMS.

In various examples, the optical fiber 10 formed by the disclosed process contains no or little germanium in the core 12. In such examples, the silica glass core 12 and the cladding 14 of the optical fiber 10 includes sufficient concentrations of up-dopant and/or down-dopants to form the relative refractive index profile within the scope of the present disclosure. The relative refractive index of the cladding 14 is less than the core 12. As discussed herein, the index-decreasing dopant (down-dopant) for use in the cladding 14 is generally fluorine.

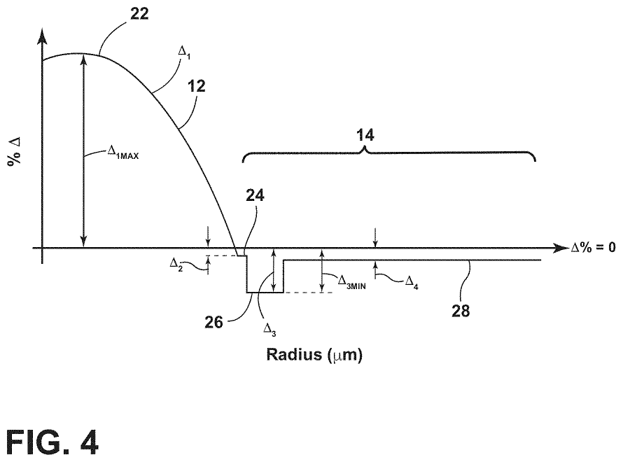

The optical fiber 10 with the relative refractive index profile 22, as illustrated in FIG. 4, is generally a single mode optical fiber 10 that has a zero dispersion wavelength, λ₀, between about 1280 nm and about 1340 nm, a dispersion slope at about 1550 nm which is less than about 0.07 ps/nm²/km, and a total dispersion between about 15 ps/nm/km and about 20 ps/nm/km at 1550 nm. However, other relative refractive index profiles 22 could be used to achieve these same or similar properties. The optical fiber 10 generally has a cutoff wavelength of about 1300 nm or less. The optical fiber 10 may have an effective area greater than about 70 μm² at 1550 nm. The optical fiber 10 may have a core radius r greater than about 3 μm or between about 3 μm and 5 μm. Additionally, the optical fiber 10 may have a mode field diameter greater than about 9 μm, between about 9.5 μm and about 11 μm, or between about 10 μm and about 11 μm at 1550 nm.

An exemplary relative refractive index profile 22 is illustrated in FIG. 4, which may be produced by the process disclosed herein. The core 12 has a non-negative relative refractive index Δ₁. The cladding region 14 has a negative relative refractive index. The cladding region 14 includes an inner cladding region 24, which has a relative refractive index Δ₂, a depressed-index cladding region or moat 26, which has a relative refractive index Δ₃, and an outer cladding region 28, which has a relative refractive index Δ₄. The moat 26 has the relative refractive index Δ₃ with a minimum relative refractive index Δ₃ mm<−0.30%. In certain aspects, the moat 26 has the relative refractive index Δ₃ with the minimum relative refractive index Δ₃ₘᵢₙ in a range between about −0.80% and about −0.30%. In various aspects, outer cladding region 28 has the relative refractive index Δ₄, where a difference between Δ₄ and Δ₃ₘᵢₙ is greater than 0.05% (e.g., Δ₄−Δ₃ₘᵢₙ>0.05%) and where Δ₄ may be greater than zero, equal to zero, or less than zero. The preform 50 drawn into the optical fiber 10 may also have the same or similar range of refractive index values.

The negative relative refractive indices may be formed using the down-dopants, such as fluorine. In various examples, the moat 26 is silica glass that is doped with a first concentration of fluorine, and the outer cladding region 28 is silica glass doped with a second concentration of fluorine. The second concentration of fluorine is less than the first concentration of fluorine, resulting in the lower relative refractive index in the moat 26. Generally, about 1 wt. % Cl doping increases A by about 0.1%, and about 1 wt. % F decreases by about 0.3%. When Cl and F are both present, the effect of each Cl and F on Δ is independent and that the concentrations balance to lead to the A disclosed herein.

The relative concentration of chlorine may also be different between the moat 26 and the outer cladding region 28. In various examples, the moat 26 has a first concentration of chlorine, and the outer cladding region 28 has a second concentration of chlorine. The second concentration of chlorine may be less than the first concentration of chlorine.

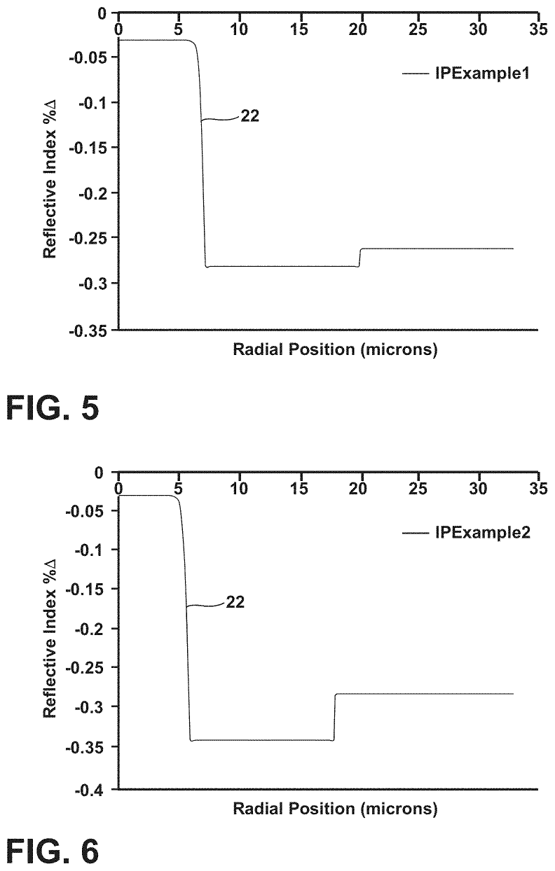

With reference to FIGS. 5-7B, exemplary refractive index profiles 22 are illustrated. The Cl and the F balance to form the refractive index profiles 22 disclosed. In FIG. 5, the maximum concentration of fluorine in the moat 26 is about 1 wt. % fluorine and the maximum concentration of fluorine in the outer cladding region 28 is about 0.9 wt. % fluorine. In some examples, the concentration of chlorine in the moat 26 is greater than 200 ppm. In other examples, the concentration of chlorine in the moat 26 is greater than 500 ppm. In additional non-limiting examples, the concentration of chlorine in the moat 26 is greater than 1000 ppm. In various examples, the concentration of chlorine in outer cladding region 28 is less than 200 ppm, and in others the concentration of chlorine in outer cladding region 28 is less than 100 ppm.

In FIG. 6, the maximum concentration of fluorine in the moat 26 is about 1.25 wt. % fluorine and the maximum concentration of fluorine in the outer cladding region 28 is about 1 wt. % fluorine. In various examples, the concentration of chlorine in the moat 26 is greater than 200 ppm, and in other examples, greater than 500 ppm. In additional non-limiting examples, the concentration of chlorine in the moat 26 is greater than 1000 ppm. In some examples, the concentration of chlorine in outer cladding region 28 is less than 200 ppm, or less than 100 ppm.

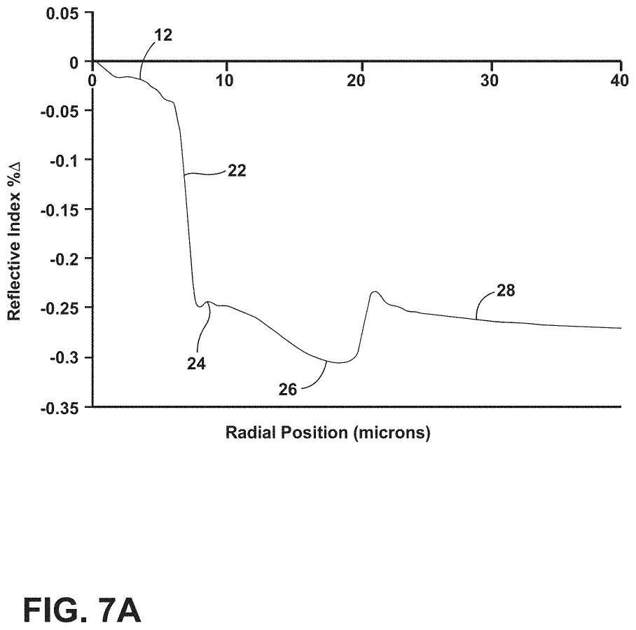

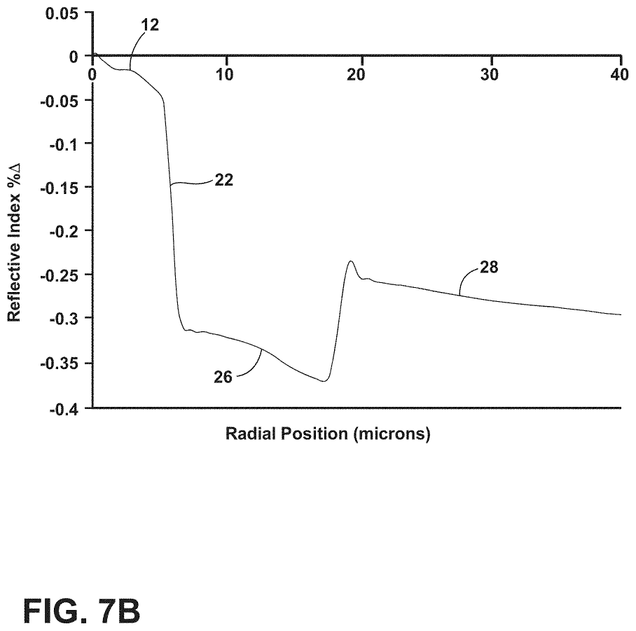

With reference to FIGS. 7A and 7B, additional exemplary refractive index profiles 22 are illustrated. The fluorine concentration is generally equal to −% Delta index/0.3. The specified Δ disclosed in FIGS. 7A and 7B are produced from the balance between the up-doping with Cl and the down-doping with F.

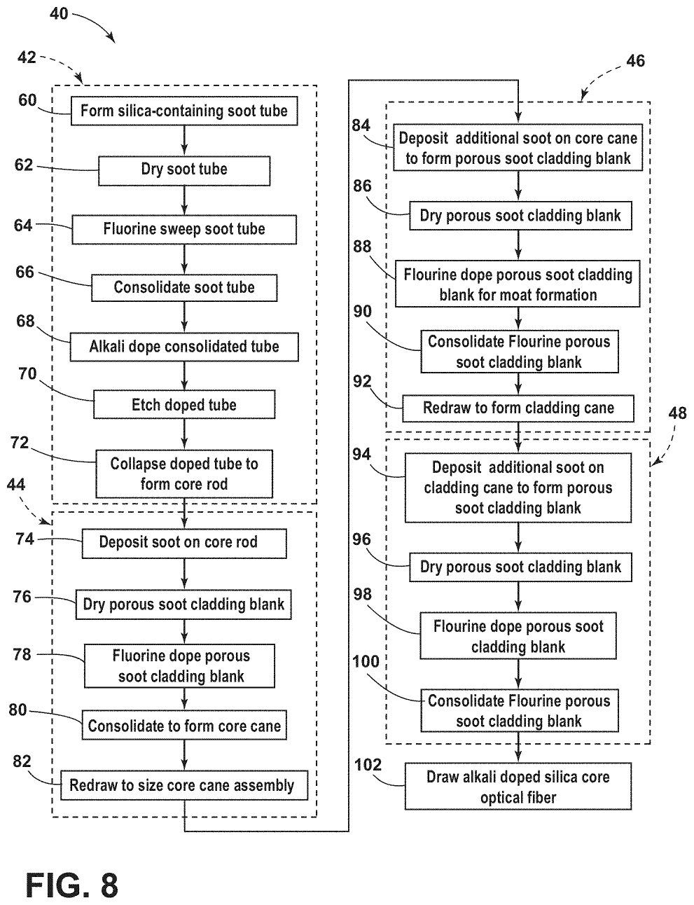

Referring to FIGS. 8-11, the optical fiber 10 having the alkali-doped core 12 and reduced attenuation is produced through a method 40 for manufacturing, which generally occurs in four stages 42, 44, 46, 48 for forming a preform 50 followed by the final draw to draw the preform 50 into the optical fiber 10. The first two stages 42, 44 involve forming the inner or central core region 16 (the first stage 42) and the outer core region 20 (the second stage 44). As described further herein, the first stage 42 includes steps 60-72 for forming the central core region 16, and the second stage 46 includes steps 74-82 for forming the outer core region 20. The next two stages 46, 48 form the cladding region 14, including the inner cladding region 24, if present, the moat 26 (the third stage 46) and the outer cladding 28 (the fourth stage 48). The third stage 46 includes steps 84-92 for forming the inner cladding region 24 and/or the moat region 26, and the fourth stage includes steps 94-100 for forming the outer cladding region 28. After the four stages 42, 44, 46, 48 of the method 40 are completed, the preform 50 is formed and ready to be drawn into the optical fiber 10 (step 102).

As described herein, various locations in the optical fiber 10 are described as “regions.” For example, the inner core region 16, the outer core region 20, and the cladding region 14 (including the inner cladding region 24, the moat region 26, and the outer cladding region 28). The corresponding location in the preform 50 may be described as a “portion.” For example, an inner core portion corresponding to the inner core region 16, an outer core portion corresponding with the outer core region 24, and a cladding portion 14 corresponding with the cladding region 14. Further, an inner cladding portion corresponds with the inner cladding region 24, a moat portion or a depressed-index cladding portion corresponds with the moat region 26, and an outer cladding region corresponds with the outer cladding region 28.

To form the preform 50, an initial or core silica soot tube 110 is formed via a soot burner 112 depositing multiple layers of silica soot onto a mandrel 114 (step 60). The soot tube 110 defines a central channel 116 that extends along a longitudinal extent of the soot tube 110. The resulting soot tube 110 is dried using chlorine drying techniques (e.g., exposure to Cl₂) (step 62). The soot tube 110 is then treated with fluorine (step 64) by exposing the porous soot tube 110 to a fluorine-containing atmosphere (e.g., fluorine sweeping with a fluorine-doping precursor, such as SiF₄), for a time and at a temperature sufficient to remove a majority or all of the chlorine remaining from the drying step (e.g., step 62). The intent of the fluorine treatment of the soot tube 110 is to remove the chlorine, such that interaction with chlorine does not contribute to the devitrification of the glass. The exposure to the fluorine-containing atmosphere may be accomplished at a temperature less than 1100° C. to avoid doping the soot tube 110 with high levels of fluorine. The fluorine treatment, however, may introduce low levels of fluorine into the soot tube 110. Small levels of fluorine may also help with lowering the fictive temperature of the glass, without negatively impacting the concentration fluctuation contribution to Rayleigh scattering.

The fluorine-doped soot tube 110 is then sintered and consolidated into a consolidated tube 118 (step 66). In various examples, the soot tube 110 includes between about 0.1 wt. % and about 0.4 wt. % of fluorine after consolidation. In certain aspects, the consolidated tube 118 may be drawn into a series of smaller consolidated tubes 118. The consolidated tube 118 or the resulting smaller tubes 118 are each assembled with a handle 120 and transferred from the mandrel 114 to the spinning lathe positioned proximate to a heat source 122. The spinning lathe may be a glass-working lathe or a modified chemical vapor deposition (MCVD) glass-forming lathe. The handle 120 may be a glass handle 120 that becomes an integral part of the preform 50. The handle 120 provides a support structure for later processing steps. The handle 120 is coupled to the lathe, where the handle 120, and consequently, the consolidated tube 118 are rotated and translated with respect to the soot burner 112.

The consolidated tube 118 defines an annular reservoir 130 for receiving an alkali metal doping material 132. The material is formed of oxygen (02) and an alkali salt, which is introduced in the annular reservoir 130. An alkali metal source compound 132 includes at least one of K, Na, Li, Cs, Rb, Br, I, and F. The alkali metal source compound 132 may be at least one of KBr, KI, and KNO₃. The alkali metal oxide diffused into the consolidated tube 118 may be K₂O, Na₂O, LiO₂, Rb₂O, and Cs₂O. The annular reservoir 130 is formed proximate to one end of the consolidated tube 118 by forging two annular neck-like deformations in the wall of the consolidated tube 118 by flame working or otherwise welding the annular reservoir 130 to the consolidated tube 118. The consolidated tube 118 has the central channel 116 for allowing the diffusion along a length of the soot tube 110.

The alkali metal source compound 132 is introduced into the central channel 116 of the consolidated tube 118 at the reservoir 130 and heated by the heat source 122 to form a vapor as the consolidated tube 118 is rotated in the lathe (step 68). The alkali halide precursor is evaporated and flows through the consolidated tube 118 (e.g., a substrate tube). A carrier gas, such as oxygen (02), is flowed into an inlet 134 of the consolidated tube 118 through a rotating seal 136. In FIG. 8, it is contemplated that the handle 120 would be located to the right (off the page), at an opposite end of the consolidated tube 118 compared to the inlet 132. The gas travels from the inlet 134 toward an opposing end of the consolidated tube 118, referred to as a downstream portion 138. The downstream portion 138 of the consolidated tube 118 is heated to facilitate diffusion of the alkali metal oxide or the alkali metal into an interior surface 140 of the consolidated tube 118.

In certain aspects, the dopant may be K₂O. The O₂ may flow over KI and a gas phase K₂O may form, which is carried downstream for doping the consolidated tube 118. More preferably, K is the dopant, and K is deposited and diffused into the consolidated tube 118. This process may be quicker than depositing K₂O and may therefore be the preferable method for doping the consolidated tube 118 with a select alkali weight percent. The downstream portion 138 of the consolidated tube 118 should be heated to a sufficient temperature to promote rapid diffusion of the alkali metal oxide or alkali metal into the interior surface 140 and to prevent devitrification of the consolidated tube 118. For example, the downstream portion 138 of the consolidated tube 118 may be heated to a temperature between about 1500° C. and about 2000° C.

The heat source 122 is traversed along a length of the consolidated tube 118 to form a moving hot spot to diffuse the alkali metal oxide into the consolidated tube 118. The alkali metal oxide may be diffused to a depth between about 100 microns and 500 microns from the interior surface 140, forming an alkali-doped consolidated tube 150. The concentration of the diffused alkali metal oxide dopant generally varies radially, with a higher concentration (in wt. %) on an inner half 152 and a lower concentration in an outer half 154. A vacuum is drawn on the alkali-doped consolidated tube 150 and the heat is increased to relax or partially collapse the alkali-doped tube 150. The alkali-doped consolidated tube 150 may be cut into base material ingots 156 for further processing.

To prevent crystallization of the alkali metal or an alkali halide (e.g., KCl), it may be advantageous that the alkali-doped consolidated tube 150, and any additional soot deposited thereon, be substantially chlorine free. Substantially chlorine free generally means exhibiting a chlorine content sufficiently low that optical losses due to alkali chlorine are generally avoided.

For example, the chlorine content in the alkali-doped consolidated tube 150 may be less than about 500 ppm by weight, less than about 100 ppm, or less than about 50 ppm. The crystalline phase may be cristabolite, which is a silica phase, with the alkali metal helping the crystalline formation via lowering viscosity. However, other crystallization may form without departing from the teachings herein.

It may be advantageous for the alkali-doped consolidated tube 150, and any additional soot deposited thereon, to be substantially free of “water.” As described herein, “water” refers to the hydroxyl group, OH. Water is generally responsible for a water peak (i.e., an absorption peak due to hydroxyl groups) centered at or about 1383 nm. This absorption peak may extend into an operating wavelength region of the optical fiber 10 (e.g., 1310 nm or 1550 nm), and therefore may have a negative effect on the attenuation of the optical fiber 10. It is generally advantageous to reduce the water peak by reducing the OH content of the glass. For example, the alkali-doped consolidated tube 150 may contain less than about 100 ppm by weight of OH. To remove the “water” from the consolidated tube 150, chlorine drying techniques may be utilized.

The alkali-doped consolidated tube 150 may be etched with an etchant, such as an aqueous HF solution (step 70). The etchant may remove a depth of silica from the interior surface of the alkali-doped consolidated tube 150 to remove or reduce impurities that may have diffused through the interior surface of the consolidated tube 150 during alkali doping and/or consolidation. It is also contemplated that a fluorine gas, such as CF₄, SF₄, NF₃, C₂F₆, or a combination thereof may be used as the etchant. The depth for the silica removal may depend on the processing conditions during the diffusion and collapsing processes. Removal to a depth of about 5% of the total diffusion depth of the alkali metal oxide may be advantageous.

Once the etching process is complete, the alkali-doped consolidated tube 150 is further heated to fully collapse the alkali-doped consolidated tube 150 downstream of the alkali metal source compound 132 to close the central channel 116 to form a cylinder of glass, referred to herein as a core rod 160 (step 72). The core rod 160 is a solid alkali-doped glass body, which is separated from the portion of the alkali-doped consolidated tube 150 that includes the annular reservoir 130. The core rod 160 at least partially forms the central core portion of the preform 50, which corresponds with the central core region 16 in the resulting optical fiber 10 obtained after drawing the preform 50. The core rod 160 may be sized by redraw. Additionally, the core rod 106 may be etched to remove some or all of hydrated glass or hydroxyl groups that may have been formed by a heat source (e.g., a torch) during the collapsing process. However, additional etching may not be necessary when a dry heat source, such as an induction or resistance heater, a plasma torch, or a dry heat source using non-hydrogen containing fuel (e.g., CO), is used for the collapsing process. The dry heat source may minimize re-wetting (e.g., reabsorption and/or diffusion of OH into) the consolidated tube 150 to reduce attenuation without supplying or producing H₂, OH, or H₂O.

The core rod 160 is generally the end product of the first stage 42 of the manufacturing method 40. The core rod 160 is then utilized as the initial product for the second stage 44 of forming the outer core portion 50 of the preform 50, corresponding with the outer core region 20. The soot burner 112 is used to deposit multiple layers of porous silica soot onto the core rod 160 to form a porous core soot blank 162 (step 74). The soot may be deposited on the core rod 160 using an outside vapor deposition (OVD) method. Generally, a flame is emitted from the soot burner 112. A silica precursor gas-vapor mixture is oxidized or combusted within the flame to form a silica-containing soot stream directed toward the core rod 160.

The porous core soot blank 162 is formed by translating the core rod 160 multiple times relative to the soot burner 112 to cause a build-up of layers of silica soot-containing layers to form a soot coating. The translational motion is generally achieved by moving the soot burner 112 relative to the core rod 160; however, the core rod 160 may be moved relative to the soot burner 112 without departing from the teachings herein. Alternatively, both the soot burner 112 and the core rod 160 may be moved. The soot coating forms at least a portion of the core 12 (e.g., an outer radial portion of the inner core region 16 or the outer core region 20) and may also include a portion of the cladding 14 (e.g., inner cladding region 24) of an optical fiber 10 drawn from the preform 50 and may be formed substantially of pure silica.

The porous core soot blank 162 is dried using chlorine drying techniques and heat (step 76). The porous core soot blank 162 is then treated with fluorine (step 78) by exposing the porous core soot blank 162 to the fluorine-containing atmosphere for a time and at a temperature sufficient to remove a majority or all of the chlorine remaining from the drying step (e.g., step 76). The fluorine-containing atmosphere may include a fluorine-doping precursor, such as SiF₄ or CF₄ and may introduce low levels of fluorine as a dopant into the porous regions of the porous core soot blank 162.

The fluorine-treated soot blank 162 is then sintered and consolidated by heating to form a core cane 164 (step 80). This process generally forms the core portion of the preform 50 that forms the core 12 having both the central core region 16 and the outer core region 20 of the optical fiber 10 drawn from the preform 50. The core cane 164 is redrawn (heated and sized to a smaller diameter) and cut as needed to form a core cane 166 (step 82) for processing in the third stage 46. Additional core layers may be added to produce a core cane 164/166 with three or more core regions of a core cane 164/166 that includes at least one core region and at least one cladding region without departing from the teachings herein.

The third stage 46 of the method 40 forms the moat portion of the preform 50 that forms the trench or moat 26 of the cladding region 14, and may also optionally produce inner cladding region 24 of the cladding region 14 of the optical fiber drawn from the preform 50. The core cane 166 produced in the second stage 44 of the method 40 is utilized as the initial product of the third stage 46 of the method 40. The core cane 166 is further processed to add additional glass layers, which ultimately form the depressed-index cladding region or moat 26 (step 84). The soot burner 112 is utilized to deposit multiple layers of soot on the core cane 166 to form a subsequent porous cladding soot blank 170. The resulting porous cladding soot blank 170 is dried using chlorine drying techniques (step 86). The porous cladding soot blank 170 is doped with a down-dopant for moat depression, preferably in a cladding-doping atmosphere containing a fluorine-doping precursor such as SiF₄ or CF₄ (step 88). In various examples, the porous cladding soot blank 170 is exposed to the fluorine-doping precursor for between about 60 minutes and 120 minutes at about 1225° C. In certain aspects, the cladding-doping atmosphere may also include SiCl₄, which may be advantageous for decreasing attenuation of the resulting optical fiber 10 as discussed further herein.

The fluorine-doped porous cladding soot blank 170 is then sintered and consolidated (step 90) by down driving through a hot zone of about 1450° C. to about 1500° C. at about 7-10 mm/min to form a cladding cane 172. The consolidating may be conducted in the presence of a non-carbon reducing agent, such as SiCl₄. In various examples, the reducing agent SiCl₄ is present during the entire consolidating process when the preform 50 goes to full-porosity. Alternatively, the SiCl₄ may be present up to a minimum density for the consolidated state (e.g., up to a density of 1.6 g/cm³, 1.7 g/cm³, 1.8 g/cm³, or 1.9 g/cm³), after which the presence of SiCl₄ may be optional. The consolidation of the cladding cane 172 is generally conducted in the absence or with minimal levels of the fluorine-doping precursor used to form the moat 26 in the cladding region 14.

In certain aspects the fluorine-doping precursor may be actively evacuated from the environment. Alternatively, the supply of the fluorine-doping precursor may be deactivated. The fluorine-doping precursor is reduced to minimal or trace levels during the consolidation of the cladding cane 172.

The reducing agent may be utilized in one or two steps during the manufacturing process, including when the porous cladding soot blank 170 is exposed to the fluorine-doping precursor (step 88), when the porous cladding soot blank 170 is consolidated into the cladding cane 172 (step 90), or during both steps. The porous cladding soot blank 170 and/or the cladding cane 172 are exposed to the non-carbon reducing agent (e.g., SiCl₄) to control an oxidation state. The SiCl₄ is included in a reducing gas environment that has a predefined concentration of the non-carbon reducing agent. In various examples, the concentration of the non-carbon reducing agent is in a range from about 0.1 vol. % to about 15 vol. % of the overall reducing gas environment during these processes. In additional examples, the concentration of the non-carbon reducing agent is in a range from about 0.5 vol. % to about 10 vol. % of the gas environment. The SiCl₄ may be introduced into the gas environment during the fluorine-doping process (step 88), the sintering process (step 90), or during both the fluorine-doping and sintering processes (steps 88, 90). In certain aspects, the treatment with SiCl₄ may be more effective during the sintering process 90 when the preform 50 goes to full-porosity. The cladding cane 172 is preferably redrawn to a pre-determined diameter into a cladding cane 174 (step 92) for over cladding and use in the fourth stage 48 of the manufacturing method 40, as discussed further herein.

The use of the reducing agent SiCl₄ in the third stage 46 assists in controlling the oxidation state of the glass forming the moat 26. However, the use of SiCl₄ during moat formation can be counterproductive to the down-doping with fluorine because when incorporated as a dopant, Cl acts as an up-dopant and counteracts the index-decreasing effect of F. The conditions at which SiCl₄ is used in third stage 46 are controlled so that the SiCl₄ controls oxidation state (by acting as a reducing agent), while not substantially introducing Cl as a dopant and thus not affecting the relative refractive index profile of the resulting optical fiber 10. In certain aspects, the concentration of SiCl₄ in the gas environment during a sintering process (step 90) is from about 0.25 mol. % to about 6 mol. %. In additional examples, the concentration of SiCl₄ in the gas environment during a sintering process (step 90) is from about 0.25 mol. % to about 4 mol. %. In further examples, the concentration of SiCl₄ in the gas environment during a sintering process (step 90) is from about 1 mol. % to about 3 mol. %.

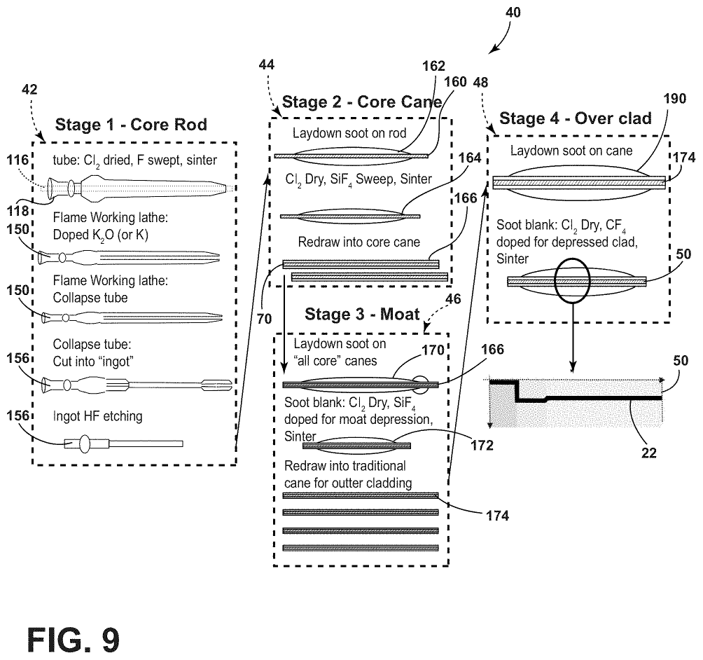

Referring still to FIGS. 5 and 6, as well as to FIG. 9, the moat formation in the third stage 46 of the manufacturing process may introduce defects that alter various properties of the resulting optical fiber 10. Under certain operating conditions, the intensity distribution of the guided optical signal extends into the moat 26 and defects in the moat 26 may interact with the optical signal to increase the attenuation of the guided optical signal. The presence of defects in the moat 26 may also interact with constituents present in the deployment environment of the optical fiber (e.g. a surrounding coating or cable, or external atmosphere) over time and lead to a time variation in the attenuation of an optical signal (referred to herein as “aging”).

A common constituent known to be present in the deployment environment of optical fibers is hydrogen. Optical fibers 10 with alkali-doped cores are utilized in terrestrial and submarine networks due to their intrinsically low attenuation of optical signals. However, during use in the field over time, such optical fibers 10 can be prone to hydrogen aging if oxygen-rich hydrogen aging defects are formed during the fiber processing. Hydrogen aging occurs when hydrogen interacts with oxygen-rich hydrogen aging defects to form defects (e.g., hydroxyl groups) that cause light of specific wavelengths to be absorbed, thus increasing the attenuation of the optical fiber 10 at those wavelengths. Typically, known oxygen-rich hydrogen aging defects have a characteristic of hydro-I response, i.e. the concentration of the oxygen-rich hydrogen aging defect continues to scale with time with a scaling factor of log(time). It is advantageous to change an oxidation state of the optical fiber 10 to significantly lower the concentration of the oxygen-rich hydrogen aging defects in the optical fiber 10, thereby reducing the prevalence of oxygen-rich hydrogen aging defects and hydrogen aging sensitivity of the optical fiber 10 or creating hydrogen aging insensitivity of the optical fiber 10.

Optical fibers 10 are routinely tested for hydrogen aging. In the hydrogen aging testing used herein, the optical fibers 10 are exposed to a gas atmosphere containing H₂ at 23° C. for a predefined period of time. The gas atmosphere includes H₂ in the presence of an inert gas. For purposes of testing hydrogen aging in the present disclosure, the H₂-containing gas atmosphere is at a total pressure of 1.0 atm and includes a partial pressure of 0.01 atm of hydrogen (H₂) gas and a partial pressure of 0.99 atm of nitrogen (N₂) gas. During the hydrogen aging test, various wavelengths of light are introduced to the optical fiber 10 and monitored for changes in attenuation as a function of exposure time to the H₂-containing gas atmosphere relative to an initial attenuation of the optical fiber 10 before exposure to the H₂-containing atmosphere.

For example, one wavelength of interest for telecommunications applications is 1383 nm. In the hydrogen aging tests disclosed herein, this wavelength is monitored. The elapsed time from when the optical fiber 10 is exposed to the H₂-containing gas to the time that the onset of an increase in absorption at 1383 nm occurs is referred to herein as the 1383 nm “time-to-peak” (or “Time-to-Peak”) value (which may be abbreviated herein as TTP). The importance of this measurement is that when exposed to H₂ for an extended time, such as one week, as described herein, reactive oxygen centers in oxygen-rich hydrogen aging defects in the optical fiber 10 react with the hydrogen to form —OH species (e.g., silanol groups) that absorb light at common telecommunications wavelengths with the absorbance being the greatest at about 1383 nm. The formation of absorbing —OH species upon exposure of the fiber to hydrogen gas over time is a process referred to herein as hydrogen aging.

In one tested example, four single-mode optical fibers having diameters of 125 μm were manufactured by forming and drawing each fiber from a different preform to test hydrogen aging. Each preform was formed by forming a core cane, forming cladding soot on the core cane, and consolidating the cladding soot. The consolidation of cladding soot included: a first phase, which was an isothermal phase in which the cladding soot was exposed to a first processing gas containing Cl₂ for about 240 minutes at a temperature of about 1150° C. to dry the cladding soot; and a second phase, in which the cladding soot was exposed to a second processing gas for about 6 hours at a temperature of between about 1150° C. and about 1500° C. The four preforms from which the four fibers were drawn were manufactured in substantially the same manner except that the processing gases for the first and second phases of each of the four preforms contained different concentrations of Cl₂ and CO (with the remaining gas including helium) as indicated in Table 1 below. Each of the fibers from Table 1 include a Germania doped core, silica inner cladding, a fluorine doped trench, and chlorine doped outer cladding. In comparison, each layer of the optical fiber 10 of the present disclosure is doped with fluorine with the exception of an inner approximately 30% of the core 12 and the fiber 10 is alkali doped. The fibers from Table 1 are similar in structure but differ from the present fiber 10 by composition.

TABLE 1

| | First phase Cl₂ | Second phase Cl₂ | Second phase CO |
|---|---|---|---|
| | concentration | concentration | concentration |
| Preform # | (vol. %) | (vol. %) | (vol. %) |
| 1 | 4.3 | 4.3 | 0 |
| 2 | 1.4 | 1.4 | 0 |
| 3 | 1.4 | 1.4 | 0.5 |
| 4 | 1.4 | 0 | 0.5 |

Each of the four fibers was exposed to a gas atmosphere at 1 atm total pressure that included a partial pressure of H₂ of 0.01 atm and a partial pressure of N₂ of 0.99 atm at 23° C. The time for the hydrogen to diffuse through the fiber cladding to the fiber core under these conditions was measured in terms of the TTP for each fiber. TTP was measured on the basis of the time dependence of the attenuation of an optical signal having a wavelength of 1383 nm and corresponded to the time following exposure of the fiber to the H₂-containing gas at which a steep increase in attenuation was observed. At exposure times less than TTP, essentially no change in attenuation was observed at 1383 nm. At an exposure time equal to TTP, an onset in an increase in attenuation at 1383 nm was observed. At exposure times greater than TTP, a pronounced increase in attenuation at 1383 nm was observed. The fiber drawn from Preform #1 had an average TTP at 1383 nm of approximately 105 hours. The fiber drawn from Preform #2 had an average TTP at 1383 nm of about 76 hours. The fiber drawn from Preform #3 had an average TTP at 1383 nm of about 58 hours. The fiber drawn from Preform #4 had an average TTP at 1383 nm of about 40 hours. This testing method may be used to determine the TTP of fibers, including the fibers 10 disclosed herein using non-carbon reducing agents, such as SiCl₄.

Low values of TTP (short TTP times) signify a low concentration of oxygen-rich hydrogen aging defects in the cladding region(s) of the optical fiber. Hydrogen from the gas atmosphere contacts the optical fiber at an exterior surface and diffuses in a radially inward direction through the cladding to the core. If the hydrogen encounters an oxygen-rich defect in the cladding as it diffuses, it reacts with it to form a hydroxyl group and diffusion terminates. Oxygen-rich hydrogen aging defects closest to the exterior surface of the optical fiber are converted to hydroxyl groups at early exposure times. Upon formation of a hydroxyl group, the oxygen-rich hydrogen aging defect is neutralized and subsequent exposure of the optical fiber to the H₂-containing gas atmosphere allows for diffusion of hydrogen to oxygen-rich hydrogen aging defects located further from the surface and closer to the core. As exposure time increases, hydroxyl groups form closer and closer to the core. At short exposure times, the hydroxyl groups are too far removed from the core to interact with the optical signal and no increase in attenuation is observed. At sufficiently long exposure times, OH groups form sufficiently close to the core region (e.g., in the core region itself or in portions of the cladding region sufficiently close to the core region) to interact with the optical signal (e.g., through absorption) to cause attenuation of the optical signal. TTP marks the exposure time at which the OH groups that form begin to become sufficiently close to the core to interact with the optical signal. A low TTP implies a short time for OH groups to form sufficiently close to the core to interact with the optical signal, which is consistent with a low concentration of oxygen-rich defects in the core region.

In order to prevent such aging and absorbance, which results in reduced transmission signal strength, optical fibers may be treated with a reducing agent to reduce the aging and absorption. One conventional approach is for optical fibers to be treated with deuterium gas to form —OD species from reactive oxygen centers, such as oxygen-rich hydrogen aging defects, present in the fiber. Unlike —OH, —OD does not absorb at 1383 nm. When using deuterium gas, oxygen leakage is also tightly controlled during a draw process of the resulting fiber. The D₂ treatment occurs on the fiber after the conclusion of the draw process and not performed during the draw itself. Deuterium gas, however, is expensive and it is desirable to identify other methods to remedy hydrogen aging.

A second conventional method for reducing oxygen-rich hydrogen aging defects include exposing the preform of the optical fiber to carbon monoxide (CO) as a reducing agent during consolidation (or doping), as illustrated in the above example associated with Table 1. However, carbon monoxide results in an absorption peak in the L-band portion of the telecommunications spectrum, generally at a wavelength at or about 1583 nm and, to a lesser extent, an absorption peak in the C-band portion of the telecommunications spectrum, generally at a wavelength at or about 1547 nm. Absorption wavelengths in the C-band spectrum and L-band spectrum negatively affect the performance of the optical fiber 10, particularly in the L-band spectrum. When using CO as the reducing agent, CO₂ may form within the fiber and affect the attenuation. The absorption peak at 1583 nm arises when CO is used as the reducing agent and may result from the CO or from other structural effects in the silica caused by carbon or CO. The absorption peak at 1583 nm affects the overall performance of the resulting fiber.

The method 40 disclosed herein utilizes a non-carbon based reducing agent during the moat formation of the manufacturing process to reduce oxygen-rich hydrogen aging defects in the optical fiber 10. The non-carbon based reducing agent is SiCl₄. The use of the non-carbon based reducing agent reduces attenuation (1) at a water peak, generally at a wavelength of about 1383 nm, (2) within the C-band spectrum, generally at a wavelength of about 1547 nm, and (3) within the L-band spectrum, generally at a wavelength of about 1583 nm. Using the non-carbon based reducing agent reduces or avoids oxygen-rich hydrogen aging defects without forming carbon dioxide CO₂, thereby reducing or eliminating undesirable absorption peaks in the L-band and/or the C-band. Moreover, the optical fiber 10 produced via the method 40 herein has a TTP at 1383 nm at 23° C. of less than 100 hours upon exposure to a H₂-containing gas atmosphere having a total pressure of 1 atm and containing a partial pressure of 0.01 atm H₂ and a partial pressure of 0.99 atm N₂. The TTP is determined using the method set forth herein associated with Table 1. As noted above, low values of TTP signify a low concentration of oxygen-rich hydrogen aging defects in the cladding region(s) of the optical fiber.

As previously noted, the third stage 46 of the manufacturing process involves doping the porous cladding soot blank 170 with fluorine to form a trench inner cladding region (e.g., the moat 26) of a profile of the optical fiber 10 (e.g., step 136). Generally, the moat index is less than an index of the core 12. There is sufficient power in the trench region or moat 26 that any defects in the moat 26 generally contribute to the aging behavior of the optical fiber 10. When the optical fiber 10 is exposed to hydrogen, if no reducing agent is used, absorption peaks at or about 1383 nm and 1550 nm are formed. The conventional method of using CO to reduce oxygen-rich hydrogen aging defects results in CO₂ formation or other contaminating or structural effect in the optical fiber 10 and may cause an absorption peak at or about 1583 nm, in the L-band, and, to a lesser extent, at or about 1547 nm in the C-band, as illustrated in FIG. 9

In the process disclosed herein, the SiCl₄ interacts with the porous cladding soot blank 170 to reduce, or eliminate, the oxygen-rich hydrogen aging defects without forming carbon dioxide CO₂ or other residual contaminating or structural effect associated with CO in the optical fiber 10.

As a result, the absorption peak at or about 1583 nm is avoided, and consequently, attenuation within the L-band transmission spectrum is reduced. The SiCl₄ makes the optical fiber 10 insensitive to hydrogen aging, or at least reduces hydrogen aging sensitivity, while simultaneously reducing or eliminating the absorption peaks in the C-band and the L-band that are known to occur when CO is used as a reducing agent.

The use of SiCl₄ as the reducing agent, rather than a carbon-based reducing agent, does not form the absorption peaks in the C-band and the L-band. Moreover, the SiCl₄ also assists with reducing water, or SiOH, within the optical fiber 10. The use of SiCl₄ eliminates the absorption peaks at or about 1583 nm and 1547 nm and reduces the water peak at or about 1383 nm.

The use of SiCl₄ during processing produces an optical fiber 10 with low attenuation at or about each of 1383 nm, 1547 nm, and 1583 nm. Due to the exposure to SiCl₄ during the formation of the moat 26, the optical fiber 10 exhibits an attenuation <0.16 dB/km at 1583 nm and an incremental peak or attenuation above a baseline at 1583 nm less than 0.0005 dB/km. In certain aspects, the optical fiber 10 may exhibit the incremental attenuation above the baseline at 1583 nm due to the CO₂ absorption of less than 0.0005 dB/km. The baseline is a best-fit attenuation over the C- and L-bands exclusive of a wavelength range centered near 1583 nm. The best fit of attenuation is a function of wavelength between about 1530 nm (e.g., a lower end of C-band) and about 1625 nm (e.g., an upper end of L-band) exclusive of the range between about 1570 nm and about 1590 nm. The baseline considers that there is no absorption at 1583 nm and produces a smooth curve across wavelengths from 1550 nm and 1625 nm, in accordance with standard spectroscopic measurements.

Further, the attenuation may be monotonically increasing between about 1570 nm and about 1600 nm, or may be monotonically increasing between about 1570 nm and about 1590 nm. The monotonically increasing attenuation is a property of the SiCl₄-treated optical fiber 10 that is absent in a comparative CO-treated fiber. Additionally or alternatively, the optical fiber 10 may exhibit an attenuation <0.16 dB/km at 1583 nm and an incremental attenuation above baseline at 1583 nm less than 0.0003 dB/km. Further, the optical fiber 10 exhibits an attenuation <0.5 dB/km at 1383 nm.

The moat-forming third stage 46 of the manufacturing process affects the overall performance of the resulting optical fiber 10. The exposure to the non-carbon reducing agent reduces attenuation of the optical fiber 10 to improve the performance of the optical fiber 10. By using SiCl₄, the attenuation in both the C-band and the L-band spectrum is reduced, which improves optical transmission and overall performance through each of these regions.

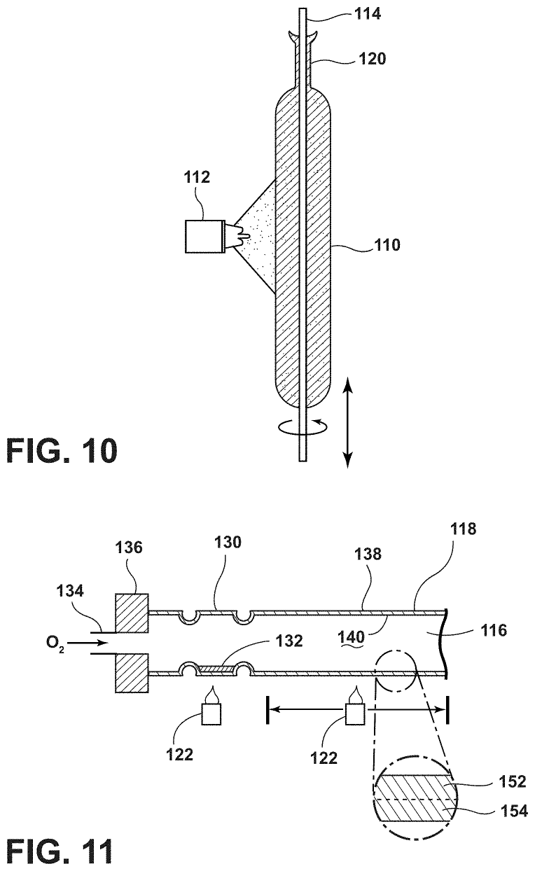

Referring again to FIGS. 5 and 6, as well as FIG. 10, when the cladding cane 174 is incorporated in preform 50, the heating that occurs in the drawing process preform 50 diffuses the alkali concentration to a greater depth within the cladding cane 174. The diffusion of the alkali metal oxide is at least partially dependent on the temperature of the glass being doped. The diffusion of the alkali metal oxide may be controlled through the draw process. By varying the draw conditions (e.g., temperature used to draw optical fiber 10 from preform 50), the alkali metal oxide concentration may be distributed within the preform 50 at a pre-determined concentration profile. In various examples, the relationship between radius r and alkali metal concentration is generally linear. Therefore, the amount of time the preform 50 remains at a selected temperature plays a factor in the alkali metal oxide diffusion and in the concentration profile of alkali metal oxide in the core and cladding regions of optical fiber 10. The time and temperature at which the cladding cane 174 and the resulting optical fiber 10 drawn from the final preform 50 are exposed during the draw process are controlled by varying the draw process by controlling draw speed and temperature of the draw furnace. For example, increasing draw speed, decreases time at a particular section of the optical fiber 10 is in a draw furnace 180 (FIG. 11) and consequently decreases the distance the alkali metal oxide dopant will diffuse within the core and/or cladding regions of the preform 50. This may result in less alkali metal oxide diffusing into the cladding 14 and, therefore, a higher alkali metal oxide concentration in the core 12 of the optical fiber 10 formed by drawing the preform 50.

Conversely, decreasing the draw speed increases the time, which may result in a decrease in the concentration of alkali metal oxide in the core 12 of the optical fiber 10 as the alkali metal oxide diffuses further into the cladding 14 of the optical fiber 10. Moreover, increasing the draw furnace temperature may increase the diffusion rate, decreasing the concentration of alkali metal oxide in the core 12 and increasing the concentration of alkali metal oxide in the cladding.

Referring again to FIGS. 5 and 6, after the depressed index cladding region 26 is formed in the third stage 46 of manufacturing, the outer cladding region 28 is formed in the fourth stage 48. The soot burner 112 is utilized to lay a layer of soot on the cladding cane 174 to form a porous overclad soot blank 190 (step 94). The resulting porous overclad soot blank 190 is dried using chlorine drying techniques (step 96). The porous overclad soot blank 190 is doped to include a depressed index cladding region with a fluorine doping precursor, such as SiF₄ (step 98). The porous overclad soot blank 190 is exposed to the fluorine-doping precursor in the absence of or with minimal levels of the reducing agent SiCl₄ as the use of SiCl₄ is generally counterproductive to the down-doping with fluorine.

The outer cladding region 28 generally has a refractive index less than the core 12 and greater than the moat 26. In various examples, the doping of the outer cladding region 28 is sufficient to achieve a relative refractive index delta % between the maximum value of the core 12 and the minimum value of the cladding 14 of, for example, between about 0.3% and about 0.4%. In the outermost cladding layer (e.g., the outer cladding region 28), the fluorine wt. % may be slightly less and be between about 0.1 wt. % and about 0.5 wt. % to achieve a relative refractive index within the preferred range and to minimize stress effects that arise when an optical fiber is drawn from preform 50. The fluorine-doped porous overclad soot blank 190 is then sintered and consolidated to form the preform 50 (step 100).

The preform 50 created through the various stages 42, 44, 46, 48 is then drawn into the optical fiber 10 to have the selected dimensions and properties (step 102). The method 40 described herein forms an alkali-doped silica optical fiber 10, which has an attenuation at 1583 nm following exposure to a H₂-containing atmosphere containing 1 vol. % H₂ and 99 vol. % N₂ for one week at 23° C. of less than 0.16 dB/km and an incremental attenuation above baseline at 1583 nm less than 0.0005 dB/km, as well as an attenuation at 1547 nm of less than <0.16 dB/km and an incremental attenuation above baseline at 1547 nm less than 0.0003 dB/km. Further, the optical fiber 10 results from drawing the preform 50 formed from the method 40 exhibits an attenuation <0.5 dB/km at 1383 nm.

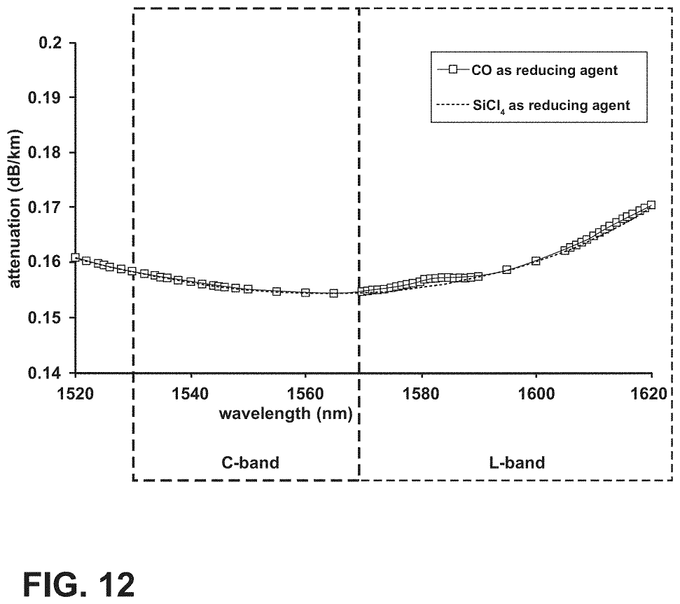

Referring still to FIG. 5, as well as FIGS. 11 and 12, the redraw processes described herein may be conducted with a draw system 200. The handle 120 is attached to the canes 164, 172 from the steps described herein. Depending on the stage of the manufacturing process, the core cane 164 or the cladding cane 172 is mounted in a moving downfeed support above the draw furnace 180. The furnace 180 generally includes a heating element 202 and a muffle 204 that is heated to a selected temperature. A sacrificial glass rod 206 may be coupled to an end of the cane 164, 172 and may be pulled by motor-driven tractors 208, causing the cane 164, 172 to be drawn at the selected rate. The draw speed or rate may be adjusted based on a sensor 210 that measures a diameter d of the cane 164, 172. The cane 164, 172 is drawn to a smaller diameter d until the cane 164, 172 is the selected diameter.

The final draw process to draw the preform 50 into the optical fiber 10 (step 102) is conducted in a similar manner (FIG. 12). The preform 50 is disposed substantially vertically within the draw furnace 180. The muffle 204 is heated to a range from about 1700° C. to about 2100° C. The optical fiber 10 is drawn from the heated preform 50 in the form of a bare optical fiber 10 (e.g., not coated with a polymeric-based material). After leaving the muffle 204, the optical fiber 10 may encounter the sensor 214 for monitoring the diameter d. The sensor 214 may provide feedback to a controller 212 for a feedback control loop to regulate the speed of the tractors 208 to maintain a substantially constant diameter d of the optical fiber 10. It is also contemplated the optical fiber 10 may be drawn through a tension monitoring device 216 to monitor the draw tension of the optical fiber 10. The tension monitoring device 216 may also communicate with the controller 212 to adjust the draw tension of the optical fiber 10.

The draw system 200 may include a cooling system 218. Once the optical fiber 10 is drawn from the preform 50, the optical fiber 10 may be cooled in a cooling tube or another device. The cooling system 218 may be coupled to, or alternatively, spaced apart from an exit of the furnace 180. The optical fiber 10 may subsequently be coated by a coating system 220, which may apply a polymeric-based coating material to an outside surface of the optical fiber 10. It is also contemplated that the coated optical fiber 10 may pass through a coating curing apparatus within the coating system 220. The coated optical fiber 10 may be wound onto a reel or spool 222.

The draw system 200 is illustrated as having the controller 212, which may have a microprocessor or a processor 224, a memory 226, and other control circuitry. The memory 226 may store instructions 228 executable by the processor 224. It is contemplated that any digital and/or analog processing circuitry and memory storage medium may be employed.

The controller 212 may modify the manufacturing processes, such as, for example, by adjusting a drawing speed of the draw system 200, modifying the temperature of the furnace 180, and/or modifying the draw tension applied to the optical fiber 10. The draw system 200 may utilize various drawing mechanisms and/or pulleys to provide the selected draw tension to the optical fiber 10 as the optical fiber 10 is drawn through the draw system 200.

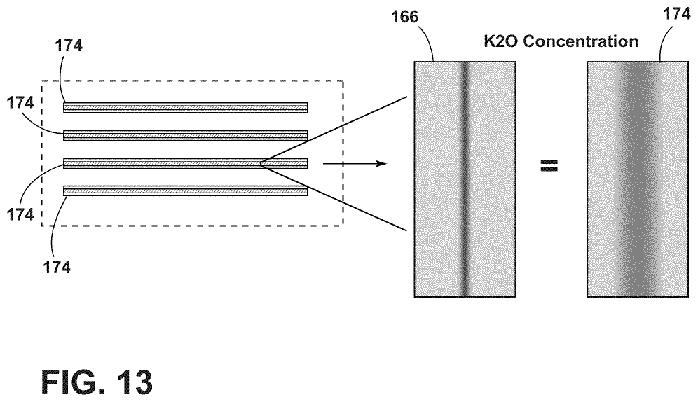

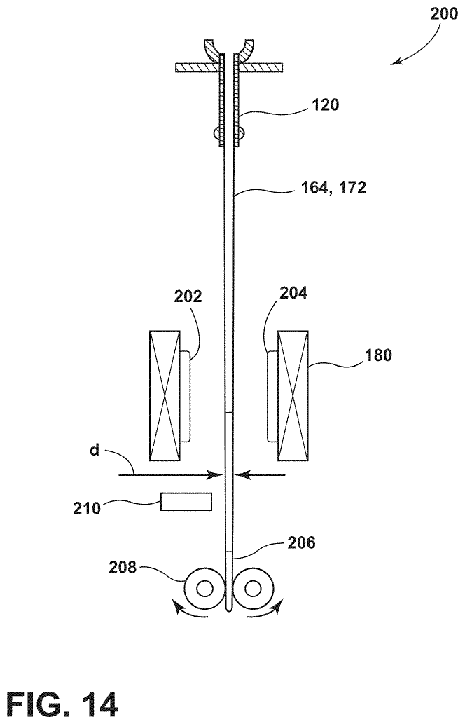

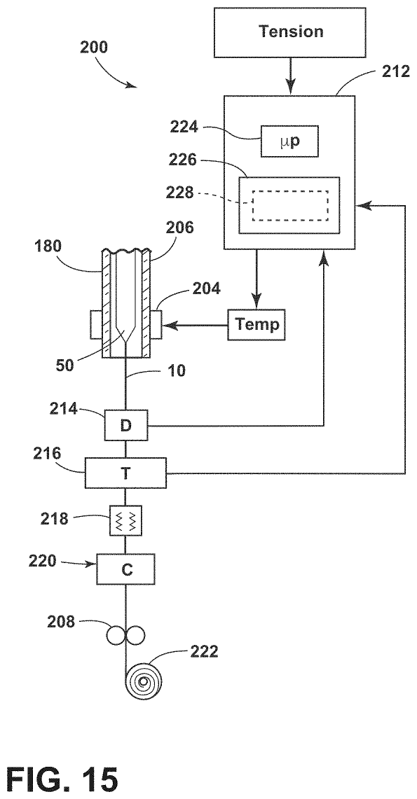

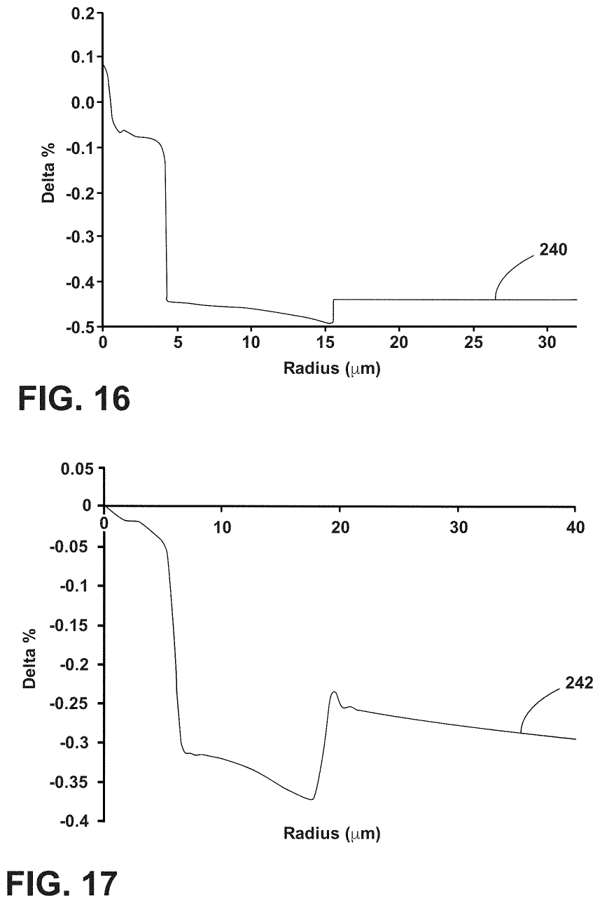

Referring to FIGS. 13 and 14, the method 40 disclosed herein may be used to create cores 12 that are ultimately drawn into different alkali-doped optical fibers 10 having different properties. A refractive index profile 240, as illustrated in FIG. 13, is a first cane profile prior to a final draw, and a refractive index 242 profile, as illustrated in FIG. 14, is a second cane profile measured prior to the final draw. Additionally, the refractive index profile 242 in FIG. 14 is in the fiber 10 space where an outer radius of the fiber 10 is about 62.5 μm. The profile 242 in normalized radial space (e.g., normalized to a maximum outer radius) is generally similar in preform 50 and a fiber space, with some variation due to alkali diffusion and stress-optic effect. Different products, both preforms 50 and optical fibers 10, having different properties may be formed using the method 40 disclosed herein.

Referring to FIGS. 1-14, the method 40 disclosed herein produces the optical fiber 10 having select properties, such as decreased attenuation at various wavelengths, select TTP, and select relative refractive indices. The optical fiber 10 includes the core 12 doped with the alkali metal oxide. The core 12 has an alkali metal oxide concentration between 0.5 wt. % and 1.5 wt. %. The cladding 14 surrounds the core 12 and includes the moat 26 and the outer cladding region 28. The moat 26 has a first concentration of fluorine and may have a first concentration of chlorine. The moat 26 has the relative refractive index Δ₃ with the minimum relative refractive index Δ₃ₘᵢₙ in a range between about −0.80% and about −0.30%. This concentration difference generally results in the moat 26 having a lower relative refractive index than the outer cladding 28. The outer cladding region 28 has a second concentration of fluorine, which is generally lower than the first concentration of fluorine. The outer cladding region 28 may also have a second concentration of chlorine, which may be less than the first concentration of chlorine. The outer cladding region 28 has the relative refractive index Δ₄ such that Δ₄−Δ₃ₘᵢₙ>0.05%. The lower chlorine concentration in the outer cladding 28 generally results from the use of SiCl₄ during the moat formation process, while the outer cladding region 28 is not exposed to SiCl₄.

Additionally, the optical fiber 10 has the TTP hydrogen aging value of less than 100 hours upon exposure at 23° C. to a H₂-containing gas atmosphere having a total pressure of 1 atm and containing a partial pressure of 0.01 atm H₂ and a partial pressure of 0.99 atm N₂. Further, due to the exposure to SiCl₄ during the formation of the moat 26, the optical fiber 10 exhibits an attenuation <0.16 dB/km at 1583 nm and an incremental attenuation above baseline at 1583 nm less than 0.0005 dB/km. Additionally or alternatively, the optical fiber 10 may exhibit an attenuation <0.16 dB/km at 1547 nm and an incremental attenuation above baseline at 1547 nm less than 0.0003 dB/km. For example, the optical fiber 10 may exhibit an attenuation <0.16 dB/km at 1547 nm and an incremental attenuation above baseline at 1547 nm of less than 0.0003 dB/km. Moreover, the optical fiber 10 may exhibit an attenuation <0.5 dB/km at 1383 nm. It is contemplated that cathodoluminescence or 240 nm absorption measurement processes could be utilized to determine whether the preform 50 was made with the method 40.

Currently, optical fibers 10 may transmit at a wavelength at or about 1550 nm and/or at about 1580 nm. Communication technology may use wavelength division multiplexing, allowing multiple wavelength channels situated on the same optical fiber 10. In such configurations, both the C-band transmission spectrum and the L-band transmission spectrum may be utilized. Removing the absorption peak from the L-band spectrum decreases the attenuation in the L-band and, consequently increases the performance of the optical fiber 10. The method 40 disclosed herein decreases attenuation while mitigating the absorption peaks at or near 1547 nm and 1583 nm as well as the water peak at or near 1383 nm.

Use of the disclosed process provides for a variety of advantages. For example, the non-carbon reducing agent reduces water (OH) formation and contaminant or structure defects associated with carbon-containing reducing agents in the optical fibers 10. Additionally, the non-carbon reducing agent may be SiCl₄, which reduces the formation of SiOH in the optical fiber 10, thereby lowering the water peak. Further, the use of SiCl₄ reduces or avoids absorption peaks in the C-band, at or about 1547 nm, and in the L-band, at or about 1583 nm. Moreover, the use of SiCl₄ decreases attenuation, which positively affects the performance of the optical fiber 10. Further, the non-carbon reducing agent reduces or eliminates the oxygen-rich hydrogen aging defects in the optical fiber 10, which decreases attenuation. Additional benefits or advantages may be realized and/or achieved.

The device and method disclosed herein is further summarized in the following paragraphs and is further characterized by combinations of any and all of the various aspects described therein.

According to a first aspect, a method of manufacturing a preform of an optical fiber where the optical fiber has a core region and a cladding region includes forming a porous cladding soot blank by depositing silica soot on a core cane. The core cane includes a core portion having a composition corresponding to at least a portion of the core region of the optical fiber and a concentration of an alkali metal oxide in a core portion of the core cane is between 0.1 wt. % and 1.5 wt. %. The method includes exposing the porous cladding soot blank to a fluorine-doping precursor in the presence of SiCl₄, the fluorine-doping precursor doping the porous cladding soot blank with fluorine to form a fluorine-doped porous cladding soot blank. The exposing comprises providing a flow of the fluorine-doping precursor to the porous cladding soot blank. The method includes consolidating the fluorine-doped porous cladding soot blank in presence or absence of a fluorine-doping precursor to form a consolidated fluorine-doped cladding cane, the consolidating comprising exposing the fluorine-doped porous cladding soot blank to SiCl₄. The composition of the core portion of the core cane comprises silica doped with an alkali metal oxide.

According to a second aspect, a method includes applying a fluorine doped silica glass outer cladding layer to a consolidated fluorine-doped cladding cane to form an optical fiber preform.

According to a third aspect, SiCl₄ is present up to a minimum density of about 1.6 g/cm³ in a consolidating step.

According to a fourth aspect, a method includes forming a porous overclad soot blank by depositing silica soot on a consolidated fluorine-doped cladding cane, exposing the porous overclad soot blank to the fluorine-doping precursor in an absence of SiCl₄, and consolidating the porous overclad soot blank to form a preform, the preform comprising a cladding portion having a composition corresponding to a cladding region of an optical fiber.

According to a fifth aspect, a cladding portion comprises a depressed-index cladding portion surrounding the core portion and an outer cladding portion surrounding the depressed-index cladding portion, the depressed-index cladding portion having a first concentration of fluorine and the outer cladding portion having a second concentration of fluorine, the second concentration of fluorine being less than the first concentration of fluorine.

According to a sixth aspect, a depressed-index cladding portion has a relative refractive index Δ₃ with a minimum relative refractive index Δ₃ₘᵢₙ in a range from −0.80% to −0.30% and an outer cladding portion has a relative refractive index Δ₄ such that Δ₄−Δ₃ₘᵢₙ>0.05%.

According to a seventh aspect, a depressed-index cladding portion comprises a first concentration of chlorine and an outer cladding portion comprises a second concentration of chlorine, the second concentration of chlorine being less than the first concentration of chlorine.

According to an eighth aspect, a method of manufacturing an optical fiber where the optical fiber has a core region and a cladding region includes forming an alkali-doped core cane. The alkali-doped core cane includes a portion having a composition corresponding to at least a portion of the core region of the optical fiber. The method includes forming a porous cladding soot blank by depositing silica soot on the alkali-doped core cane and exposing the porous cladding soot blank to a fluorine-doping precursor. The fluorine-doping precursor dopes the silica soot with fluorine to form a fluorine-doped porous cladding soot blank. The step of exposing comprises providing a flow of the fluorine-doping precursor to the porous cladding soot blank. The method includes consolidating the fluorine-doped porous cladding soot blank in the absence or presence of the flow of the fluorine-doping precursor to form a fluorine-doped cladding cane, the fluorine-doped cladding cane having a portion with a composition corresponding to the cladding region of the optical fiber. The step of exposing comprises exposing the porous cladding soot blank to the fluorine-doping precursor in the presence of SiCl₄ or the step of consolidating comprises exposing the fluorine-doped porous cladding soot blank to SiCl₄.

According to a ninth aspect, a step of exposing comprises exposing a porous cladding soot blank to a fluorine-doping precursor in the presence of SiCl₄ and a step of consolidating comprises exposing a fluorine-doped porous cladding soot blank to SiCl₄ According to a tenth aspect, a method includes drawing an optical fiber from a preform comprising a fluorine-doped cladding cane. The optical fiber exhibits an attenuation <0.16 dB/km at 1583 nm. The attenuation monotonically increases between about 1570 nm and about 1590 nm.

According to an eleventh aspect, a step of forming an alkali-doped core cane comprises evaporating an alkali halide precursor and flowing it through a substrate tube, traversing a heating burner on an outside of the substrate tube with the alkali halide vapor flowing through the tube allowing alkali to dope the inside of the substrate tube and diffusing through the tube wall, and collapsing the substrate tube to form a portion of the core cane. The portion of the core cane has a the composition having an alkali concentration between 0.1 wt. % and 1.5 wt. %.

According to a twelfth aspect, a portion with a composition corresponding to a cladding region of an optical fiber has a relative refractive index Δ₃ with a minimum relative refractive index

Δ₃ₘᵢₙ<−0.30%.

According to a thirteenth aspect, a method includes forming an outer cladding region by depositing silica soot on a fluorine-doped cladding cane to form a porous overclad soot blank. The outer cladding region hays a relative refractive index Δ₄ such that Δ₄−Δ₃ₘᵢₙ>0.05%. The method includes consolidating the porous overclad soot blank to form a preform and drawing an optical fiber from the preform. The optical fiber exhibits an attenuation <0.16 dB/km at 1583 nm and an incremental attenuation above baseline at 1583 nm less than 0.0005 dB/km.

According to a fourteenth aspect, a step of consolidating the porous overclad soot blank comprises exposing a porous overclad soot blank to a fluorine-doping precursor in the absence of SiCl₄.

According to a fifteenth aspect, when present in a step of exposing or a step of consolidating, the SiCl₄ is provided in a gas atmosphere and a concentration of the SiCl₄ in the gas atmosphere is between 0.1 vol. % and 15 vol. %.

According to a sixteenth aspect, an optical fiber includes a core region, the core region comprising silica glass doped with an alkali metal oxide. A cladding region surrounds and is directly adjacent to the core region. The cladding region comprises a depressed-index cladding region surrounding the core region. The depressed-index cladding region comprises silica glass doped with a first concentration of fluorine. The depressed-index cladding region has a relative refractive index Δ₃ with a minimum relative refractive index Δ₃ₘᵢₙ in a range from −0.80% to −0.30%. The cladding region includes an outer cladding region surrounding and directly adjacent to the depressed-index cladding region. The outer cladding region comprises silica glass doped with a second concentration of fluorine less than the first concentration of fluorine. The outer cladding region has a relative refractive index Δ₄ such that Δ₄−Δ₃ₘᵢₙ>0.05%. The optical fiber has a time-to-peak (TTP) hydrogen aging value at 23° C. of less than 100 hours upon exposure of the optical fiber to a gas atmosphere having a total pressure of 1 atm and containing a partial pressure of 0.01 atm H₂ and a partial pressure of 0.99 atm N₂. The optical fiber exhibits an attenuation <0.16 dB/km at 1583 nm and the attenuation monotonically increases between about 1570 nm and about 1600 nm.

According to a seventeenth aspect, a core region has an alkali metal oxide concentration between 0.5 wt. % and 1.5 wt. %.

According to an eighteenth aspect, an alkali metal oxide includes at least one of K₂O, Na₂O, LiO₂, Rb₂O, and Cs₂O.

According to a nineteenth aspect, an optical fiber exhibits an attenuation <0.16 dB/km at 1547 nm and an incremental attenuation above baseline at 1547 nm less than 0.0003 dB/km.

According to a twentieth aspect, an optical fiber exhibits an attenuation <0.5 dB/km at 1383 nm.

According to a twenty first aspect, a preform is configured to be drawn into an optical fiber of any of the preceding aspects.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

What is claimed is:

1. A method of manufacturing a preform of an optical fiber, the optical fiber having a core region and a cladding region, the method comprising:
forming a porous cladding soot blank by depositing silica soot on a core cane, the core cane including a core portion having a composition corresponding to at least a portion of the core region of the optical fiber, and wherein a concentration of an alkali metal oxide in a core portion of the core cane is between 0.1 wt. % and 1.5 wt. %;
exposing the porous cladding soot blank to a fluorine-doping precursor in the presence of SiCl₄, the fluorine-doping precursor doping the porous cladding soot blank with fluorine to form a fluorine-doped porous cladding soot blank, the exposing comprising providing a flow of the fluorine-doping precursor to the porous cladding soot blank; and
consolidating the fluorine-doped porous cladding soot blank in presence or absence of a fluorine-doping precursor to form a consolidated fluorine-doped cladding cane, the consolidating comprising exposing the fluorine-doped porous cladding soot blank to SiCl₄.

2. The method of claim 1, further comprising:
applying a fluorine doped silica glass outer cladding layer to the consolidated fluorine-doped cladding cane to form an optical fiber preform.

3. The method of claim 1, wherein the SiCl₄ is present up to a minimum density of about 1.6 g/cm³ in the consolidating step.

4. The method of claim 1, further comprising:
forming a porous overclad soot blank by depositing silica soot on the consolidated fluorine-doped cladding cane;
exposing the porous overclad soot blank to the fluorine-doping precursor in the absence of SiCl₄; and
consolidating the porous overclad soot blank to form the preform, the preform comprising a cladding portion having a composition corresponding to the cladding region of the optical fiber.

5. The method of claim 4, wherein the cladding portion comprises a depressed-index cladding portion surrounding the core portion and an outer cladding portion surrounding the depressed-index cladding portion, the depressed-index cladding portion having a first concentration of fluorine and the outer cladding portion having a second concentration of fluorine, the second concentration of fluorine being less than the first concentration of fluorine.

6. The method of claim 5, wherein the depressed-index cladding portion has a relative refractive index Δ₃ with a minimum relative refractive index Δ₃ₘᵢₙ in a range from −0.80% to −0.30% and the outer cladding portion has a relative refractive index Δ₄ such that Δ₄−Δ₃ₘᵢₙ>0.05%.

7. The method of claim 5, wherein the depressed-index cladding portion comprises a first concentration of chlorine and the outer cladding portion comprises a second concentration of chlorine, the second concentration of chlorine being less than the first concentration of chlorine.

8. A method of manufacturing an optical fiber, the optical fiber having a core region and a cladding region, the method comprising:
forming an alkali-doped core cane, the alkali-doped core cane including a portion having a composition corresponding to at least a portion of the core region of the optical fiber;
forming a porous cladding soot blank by depositing silica soot on the alkali-doped core cane;
exposing the porous cladding soot blank to a fluorine-doping precursor, the fluorine-doping precursor doping the silica soot with fluorine to form a fluorine-doped porous cladding soot blank, the step of exposing comprising providing a flow of the fluorine-doping precursor to the porous cladding soot blank; and
consolidating the fluorine-doped porous cladding soot blank in the absence or presence of the flow of the fluorine-doping precursor to form a fluorine-doped cladding cane, the fluorine-doped cladding cane having a portion with a composition corresponding to the cladding region of the optical fiber, and
wherein the step of exposing comprises exposing the porous cladding soot blank to the fluorine-doping precursor in the presence of SiCl₄ or the step of consolidating comprises exposing the fluorine-doped porous cladding soot blank to SiCl₄.

9. The method of claim 8, wherein the step of exposing comprises exposing the porous cladding soot blank to the fluorine-doping precursor in the presence of SiCl₄ and the step of consolidating comprises exposing the fluorine-doped porous cladding soot blank to SiCl₄.

10. The method of claim 9, further comprising:
drawing the optical fiber from a preform comprising the fluorine-doped cladding cane, the optical fiber exhibiting an attenuation <0.16 dB/km at 1583 nm, and wherein the attenuation monotonically increases between about 1570 nm and about 1590 nm.

11. The method of claim 8, wherein the step of forming the alkali-doped core cane comprises:
evaporating an alkali halide precursor and flowing it through a substrate tube;
traversing a heating burner on the outside of the substrate tube with the alkali halide vapor flowing through the tube allowing alkali to dope the inside of the substrate tube and diffusing through the tube wall;
collapsing the substrate tube to form a portion of the core cane;
wherein the portion of the core cane has a composition having an alkali concentration between 0.1 wt. % and 1.5 wt. %.

12. The method of claim 8, wherein the portion with a composition corresponding to the cladding region of the optical fiber has a relative refractive index Δ₃ with a minimum relative refractive index Δ₃ₘᵢₙ<−0.30%.

13. The method of claim 12, further comprising:
forming an outer cladding region by depositing silica soot on the fluorine-doped cladding cane to form a porous overclad soot blank, the outer cladding region having a relative refractive index Δ₄ such that Δ₄−Δ₃ₘᵢₙ>0.05%;
consolidating the porous overclad soot blank to form a preform; and
drawing the optical fiber from the preform, the optical fiber exhibiting an attenuation <0.16 dB/km at 1583 nm and an incremental attenuation above baseline at 1583 nm less than 0.0005 dB/km.

14. The method of claim 13, wherein the step of consolidating the porous overclad soot blank comprises:
exposing the porous overclad soot blank to the fluorine-doping precursor in the absence of SiCl₄.

15. The method of claim 8, wherein when present in the step of exposing or the step of consolidating, the SiCl₄ is provided in a gas atmosphere and a concentration of the SiCl₄ in the gas atmosphere is between 0.1 vol. % and 15 vol. %.

16. An optical fiber, comprising:
a core region, the core region comprising silica glass doped with an alkali metal oxide; and
a cladding region surrounding and directly adjacent to the core region, the cladding region comprising:
a depressed-index cladding region surrounding the core region, the depressed-index cladding region comprising silica glass doped with a first concentration of fluorine, the depressed-index cladding region having a relative refractive index Δ₃ with a minimum relative refractive index Δ₃ₘᵢₙ in a range from −0.80% to −0.30%; and
an outer cladding region surrounding and directly adjacent to the depressed-index cladding region, the outer cladding region comprising silica glass doped with a second concentration of fluorine less than the first concentration of fluorine, the outer cladding region having a relative refractive index Δ₄ such that Δ₄−Δ₃ₘᵢₙ>0.05%, and
wherein the optical fiber has a time-to-peak (TTP) hydrogen aging value at 23° C. of less than 100 hours upon exposure of the optical fiber to a gas atmosphere having a total pressure of 1 atm and containing a partial pressure of 0.01 atm H₂ and a partial pressure of 0.99 atm N₂, and
wherein the optical fiber exhibits an attenuation <0.16 dB/km at 1583 nm and the attenuation monotonically increases between about 1570 nm and about 1600 nm.

17. The optical fiber of claim 16, wherein the core region has an alkali metal oxide concentration between 0.5 wt. % and 1.5 wt. %.

18. The optical fiber of claim 16, wherein the optical fiber exhibits an attenuation <0.16 dB/km at 1547 nm and an incremental attenuation above baseline at 1547 nm less than 0.0003 dB/km.

19. The optical fiber of claim 16, wherein the optical fiber exhibits an attenuation <0.5 dB/km at 1383 nm.

20. A preform configured to be drawn into the optical fiber of claim 16.
